(19) United States
(12) Patent Application Publication
(10) Pub. No.: US 2025/0243355 A1
(43) Pub. Date: Jul. 31, 2025

(54) SOFT THERMOPLASTIC OLEFINS AND PRODUCTS MADE THEREFROM

(71) Applicant: Dow Global Technologies LLC, Midland, MI (US)

(72) Inventors: Mark P. Allen, Bruce Township, MI (US); Matthew A. Stempki, Midland, MI (US); Lena T. Nguyen, Lake Jackson, TX (US)

(21) Appl. No.: 18/703,389

(22) PCT Filed: Nov. 29, 2022
(86) PCT No.: PCT/US2022/051173

§ 371 Date: Apr. 22, 2024

Related U.S. Application Data
(60) Provisional application No. 63/284,021, filed on Nov. 30, 2021.

(51) Int. Cl. C08L 23/16

(52) U.S. Cl. CPC C08L 23/16; C08L 2205/025

(57) ABSTRACT

An elastomer skin composition comprising at least one ethylene propylene diene terpolymer (EPDM) and at least one polypropylene copolymer component, and products made thereof.

### FIELD

The present disclosure relates to soft thermoplastic olefins. More particularly, the present disclosure relates to the production and use of soft thermoplastic olefins with enhanced visual perception properties and rheology in automotive parts.

### INTRODUCTION

Automotive interiors are a key area of differentiation for automotive part manufacturers. Soft thermoplastic olefin (TPO) skins are often used to replace leather while achieving leather like haptics and aesthetics. Soft TPO skins are often used to cover hard surfaces such as instrument and door panels. It is envisioned that future vehicles will have surfaces that are leather like in appearance while also being functional. These leather-like skins might be transparent, translucent, or dead front in appearance, which will provide a leather-like appearance when not in use and allow light or images to illuminate through when in use. Symbols or switches could then be imbedded within or under the dead front skins. Alternatively, these soft skins could be partially pigmented to provide a lacquer like appearance when covering surfaces like wood, fibers, fabrics and composite structures.

Traditional soft skins typically include thermoplastic vulcanization, rheology modified TPO, PVC or polyolefin elastomer (POE) and polypropylene compounds. Thermoplastic vulcanizates (TPV) involve rubber crosslinked domains in a polypropylene (PP) continuous morphology, which often exhibits high levels of haze and low clarity due to the crosslinked rubber domains in a continuous PP phase. Crosslinking agents and additives used to make TPV and rheology modification can also lead to undesirable odors and VOC emissions. PVC is undesirable due to volatile organic content, odor, high chlorine content and health concerns associated with phthalate ester plasticizers. TPO skins are, at present, unable to be produced with the requisite physical abilities required for the envisioned applications mentioned above. Formulating a TPO skin out of POE and PP compound to produce a sheet with high light transmittance, high clarity, low haze, soft to the touch (low Shore A), extrudes without excessive torque and thermoforms well is difficult.

Thus, there is a need to develop a soft thermoplastic elastomer skin with high total light transmittance, high clarity, low haze, is soft to the touch (low Shore A), temperature resistance up to 120° C., which doesn't exhibit excessive melt viscosity during extrusion, and thermoforms well.

Light scattering from crystallites in compounds can cause haze to occur. Use of excessive amounts of amorphous polyolefin elastomer to minimize crystallinity, minimize crystallite structures and reduce hardness can cause the sheet produced with the compound to not meet the desired in-use temperature resistance. When polypropylene is compounded into the polyolefin elastomer to improve temperature resistance, it can cause dispersed polypropylene domains that have a different refractive index than the continuous polyolefin elastomer major phase, which can scatter light resulting in haze. Crosslinking agents and additives used to make TPV and rheology modification can also lead to undesirable odors and VOCs.

In addition, polypropylene addition increases the hardness of the compound, which will make the skin feel hard and stiff. From a processing perspective, molecular weight and rheology of the compound need to be such that excessive torque doesn't occur during extrusion, and the material exhibits good melt strength so that sheet made from the compound doesn't thin during thermoforming. Thus, there is a need for soft thermoplastic olefins with enhanced visual perception properties and rheology in automotive parts.

### SUMMARY

A purpose of the present disclosure is to provide a compound based on a defined ethylene propylene diene terpolymer architecture combined with a clarified copolymer polypropylene to achieve balanced performance and processability including desired visual, temperature resistance, and rheological properties without reactive extrusion. The ethylene propylene diene terpolymer is a synthetic elastomer, and often referred to as EPDM, an acronym for “ethylene propylene diene M-class rubber,” which is a name assigned to this material within the classification established in ASTM D1418, “Standard Practice for Rubber and Rubber Lattices-Nomenclature.”

In one embodiment, a thermoformed soft TPO skin may be used to cover hard surfaces in an automotive (car, truck, bus, etc.) interior, such as instrument panels, door panels, armrest and consoles. These skins are transparent or translucent to allow light or images to transmit through the skin. Alternatively, the skins maybe pigmented or constructed in a way to achieve a dead front appearance.

The TPO elastomer skin composition may comprise an ethylene propylene diene terpolymer (EPDM) and a copolymer polypropylene component, wherein the EPDM is at levels of greater than or equal to 70 wt % and less than 85 wt % of the composition. In one embodiment, the elastomer skin composition comprises 70 wt % to 77.5 wt % of the at least one EPDM. Levels of EPDM (or EPDM plus other ethylene/α-olefin interpolymer) greater than 85 wt % will result in a material that will soften when exposed to 120° C. use temperature and lose its grain structure if embossed or change in appearance. If the EPDM (or EPDM plus other ethylene/α-olefin interpolymer) is less than 70 wt %, then Shore A hardness of the composition may exceed the desired <88 and/or stiffness might be high (feel stiff to the touch).

The TPO elastomer skin composition may further comprise an EPDM component with ethylene content of greater than 60 wt % and less than 80 wt %. In one embodiment, the ethylene content of the EPDM component ranges from greater than 60 wt % and less than 80 wt %. In one embodiment, the ethylene content of the EPDM component ranges from greater than 65 wt % and less than 75 wt %. If ethylene content is greater than 80 wt %, then the Shore A hardness of the composition may exceed the desired level (less than 88) and the composition's stiffness might be high and feel stiff to the touch. If the ethylene content is less than 60 wt %, then the EPDM component is difficult to handle when feeding it into an extruder. EPDM in a granular or pellet form may be desired in some embodiments. EPDM with ethylene content less than 60 wt % are not typically available in a free flowing granule form due to the tendency of the material to block. The composition may also feature a diene content of less than 5 wt % of the composition.

The TPO elastomer skin composition may further comprise a clarified polypropylene random copolymer (rcPP) content of greater than 15 wt % and less than or equal to 30 wt % of the composition. In one embodiment, the rcPP component constitutes 22.5 wt % to less than or equal to 30 wt % of the TPO elastomer skin composition. The rcPP may also include an optional clarifying agent. If polypropylene level is greater than 30 wt %, then Shore A hardness of the composition may exceed the desired level (less than 88) and might feel stiff. If the composition was to comprise less than 15 wt % polypropylene, then film/sheet made with the compound might soften when exposed to 120° C. use temperature and lose its grain structure if embossed.

Additionally, the composition, in one preferred embodiment features a melt flow rate (MFR) of polypropylene which is less than 10 g/10 min. In one embodiment MFR of the polypropylene components range from 0.01 g/10 min to 10 g/10 min. In one embodiment MFR of the polypropylene components range from 0.1 g/10 min to 10 g/10 min or from 0.25 g/10 min to 10 g/10 min. If more than 10 g/10 min, then the large PP domains in the elastomer continuous phase might lead to high levels of haze and low clarity. The EPDM or elastomer component may also feature a Mooney viscosity of greater than 30 MU and less than 60 MU (ML1+4 at 125° C.). In one embodiment, the Mooney viscosity ranges from 35 MU to less than 55 MU (ML1+4 at 125° C.).

The composition described above may be used to produce a compound (e.g., a TPO skin) which preferably features the following physical properties: a capillary viscosity at 215° C. of <1900 Pa·s at a shear rate of 100 s⁻¹, a Shore A hardness of less than 88, an elongational viscosity ratio greater than 1.5 at a Hencky strain ratio of 1.0:0.25, and an elongational viscosity at 0.25 Hencky strain greater than 90,000 Pa·s (190° C. and 0.1 s⁻¹).

For thermoforming applications, it is desired that the elongational viscosity increases as the strain increases. Soft TPO skin parts may experience draw during thermoforming of up to 100% (1 Hencky strain) or more. If the elongational viscosity doesn't increase significantly as the part draws, then local thinning or tearing can occur in high draw areas. It is desired that the elongational viscosity ratio at 1.0/0.25 Hencky strains be greater than 1.5 to prevent areas that are locally strained to high levels from further straining, which could result in thinning or tearing. It is further desirable to have the elongational viscosity at 0.25 cm/cm Hencky strain to be greater than 90,000 Pa·s to prevent excessive sagging during heating of the skin or sheet during thermoforming.

Yet other preferred physical capabilities of a formed skin include total transmittance, haze, and clarity. Total transmittance is the ratio of total transmitted light to incident light. Total transmittance is reduced by reflectance and absorbance. Haze is the amount of light that is subject to Wide Angle Scattering (at an angle greater than 2.5° from normal). Clarity is the amount of light that is subject to Narrow Area Scattering (at an angle less than 2.5° from normal). Total transmittance greater than 88%, clarity greater than 65%, and haze of less than 35% is desired when extruded into a 0.5 mm thick film without colorants. The greater than 88% total transmittance is desired to ensure the film has the needed ability to transmit light all the way through the formed skin or film without being absorbed or reflected. The clarity of greater than 65% is desired to ensure images are sharp and not distorted. This is also true for the haze needing to be less than 35% (to prevent light scattering and image distortion).

It should be noted that in some embodiments in the present invention, the EPDM phase is not crosslinked nor is it rheology modified during compounding. Crosslinking agents and additives used to make TPV and rheology modification can also lead to undesirable odors and VOCs. Additionally, the rubber phase morphology is such that discrete and large rubber domains form. The large rubber domains might cause high levels of haze due to the refractive index mismatch between the rubber discontinuous and PP continuous phases.

It is to be understood that both the foregoing general description and the following detailed description are exemplary and explanatory only and are not restrictive of the claims.

### DETAILED DESCRIPTION

Unless defined otherwise, all technical and scientific terms used herein have the same meaning as commonly understood by one of ordinary skill in the art to which the method belongs. Also, all publications, patent applications, patents, and other references mentioned herein are incorporated by reference. As disclosed herein, the term “composition”, “formulation” or “mixture” refers to a physical blend of different components, which is obtained by mixing simply different components by a physical means. As disclosed herein, “and/or” means “and, or as an alternative”. All ranges include endpoints unless otherwise indicated.

### Ethylene Propylene Diene Terpolymer (EPDM)

Suitable diene comonomers include conjugated and nonconjugated dienes. A non-conjugated diolefin is conventionally used as a cure site for cross-linking. The nonconjugated diolefin can be a C6-C15 straight chain, branched chain or cyclic hydrocarbon diene. Illustrative nonconjugated dienes are straight chain acyclic dienes such as 1,4-hexadiene and 1,5-heptadiene; branched chain acyclic dienes such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,5-dimethyl-1,7-octadiene, 5,7-dimethyl-1,7-octadiene, 1,9-decadiene and mixed isomers of dihydromyrcene; single ring alicyclic dienes, such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes, such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene and 5-cyclohexylidene-2-norbornene. The diene is preferably a nonconjugated diene, selected from the group consisting of ENB, 1,4-hexadiene, 7-methyl-1,6-octadiene, more preferably, ENB.

Suitable conjugated dienes include 1,3-pentadiene, 1,3-butadiene, 2-methyl-1,3-butadiene, 4-methyl-1,3-pentadiene, or 1,3-cyclopentadiene. The EPDM diene monomer content, whether it comprise a conjugated diene, a non-conjugated diene or both, falls within the limits specified above for non-conjugated dienes.

Although preferred interpolymers are substantially free of any diene monomer that typically induces long chain branching (LCB), one may include such a monomer, if costs are acceptable and desirable interpolymer properties, such as processability, tensile strength and elongation, do not degrade to an unacceptable level. Such diene monomers include dicyclopentadiene, NBD, methyl norbornadiene, vinyl norbornene, 1,6-octadiene, 1,7-octadiene, and 1,9-decadiene. When added, such monomers are typically added in an amount within a range from greater than zero to 3 weight percent, more preferably from greater than zero to 2 weight percent, based on interpolymer weight.

The ethylene/α-olefin (EAO) interpolymer(s) of this invention may comprise branched or unbranched ethylene/α-olefin interpolymers, or a blend of two or more branched and/or unbranched interpolymers. The presence or absence of branching in the ethylene/α-olefin interpolymers, and if branching is present, the amount of branching, can vary widely, and the level of branched needed is largely dependent upon the thermoforming process, and the amount of branched polypropylene in the blend. Thermoforming processes using a male mold, e.g., a roller used to impart a pattern to a smooth sheet of plastic made from the blend, preferably form the plastic sheet from a composition of one or more medium branched to highly branched ethylene/α-olefin interpolymers and a branched polypropylene.

The nature of the ethylene/α-olefin (EAO) branching, if present, is not critical to the practice of this invention, and as such, it can vary to convenience. Preferably, the branching is long chain branching (LCB). The ability to incorporate LCB into polymer backbones has been known and practiced for many years. In U.S. Pat. No. 3,821,143, a 1,4-hexadiene was used as a branching monomer to prepare ethylene/propylene/diene polymers having LCB. Such branching agents are sometimes referred to as H branching agents. U.S. Pat. Nos. 6,300,451 and 6,372,847 also use various H type branching agents to prepare polymers having LCB. In U.S. Pat. No. 5,278,272, it was discovered that constrained geometry catalysts (CGC) have the ability to incorporate vinyl terminated macromonomers into the polymer backbone to form LCB polymers. Such branching is referred to as T type branching. Each of these patents (U.S. Pat. Nos. 3,821,143; 6,300,451; 6,372,847 and 5,278,272) is incorporated, herein, in its entirety, by reference.

Compositions disclosed herein may include EPDM at levels of greater than or equal to 70 wt % and less than 85 wt % of the composition, or 70 wt % to 77.5 wt % of the composition.

### Polypropylene Copolymer Component

Suitable propylene based polymers for use herein includes, but is not limited to, random polypropylene copolymer, and the like. In one embodiment, the elastomer skin composition comprises based on the weight of the elastomer skin composition greater than 15 wt % and less than or equal to 30 wt % of at least one polypropylene copolymer, as well as at least one EPDM, and the total weight of the at least one EPDM and the at least one polypropylene copolymer component adds up to 100% based on the weight of the elastomer skin composition. In one embodiment, the elastomer skin composition comprises based on the weight of the elastomer skin composition 22.5 wt % to 30 wt % of at least one polypropylene copolymer, as well as at least one EPDM, and the total weight of the at least one EPDM and the at least one polypropylene copolymer component adds up to 100% based on the weight of the elastomer skin composition.

Suitable propylene copolymers include propylene/ethylene, propylene/1-butene, propylene/1-hexene, propylene/4-methyl-1-pentene, propylene/1-octene, propylene/ethylene/1-butene, propylene/ethylene/ENB, propylene/ethylene/1-hexene, propylene/ethylene/1-octene, propylene/styrene, and propylene/ethylene/styrene copolymers and terpolymers.

Suitable propylene copolymers include random copolymer polypropylene that has comonomer units arranged randomly along the polypropylene backbone. Comonomers typically include ethylene but can also include butene or other α-olefins. The random copolymer propylene contains about 1 wt % to 10 wt % comonomer content. These grades of polypropylene are often chosen when enhanced clarity in the propylene phase is desired. Preferable random copolymer polypropylene has one, some, or all of the following properties:
(i) a density from 0.89 g/cc to 0.91 g/cc, or 0.90 g/cc; and/or
(ii) a MFR from 0.01 g/10 min to 10 g/10 min, or from 0.1 g/10 min to 10 g/10 min, or from 0.25 g/10 min to 10 g/10 min.

Suitable polypropylenes include propylene homopolymer. Preferable propylene homopolymer has one, some, or all of the following properties:
(i) a density from 0.89 g/cc to 0.91 g/cc, or 0.90 g/cc; and/or
(ii) a MFR from 0.01 g/10 min to 10 g/10 min, or from 0.1 g/10 min to 10 g/10 min, or from 0.25 g/10 min to 10 g/10 min.

Suitable polypropylenes include propylene impact copolymer. The propylene impact copolymer has a rubber phase (or a discontinuous phase) of discrete domains of ethylene/propylene copolymer dispersed throughout a matrix phase (or a continuous phase) of propylene homopolymer. The propylene impact copolymer contains about 5 wt % to 25 wt % ethylene/propylene rubber phase, based on the total weight of the propylene impact copolymer.

Preferable propylene impact copolymer has one, some, or all of the following properties;
(i) a density from 0.89 g/cc to 0.91 g/ce, or 0.90 g/cc; and/or
(ii) a MFR from 0.01 g/10 min to 10 g/10 min, or from 0.1 g/10 min to 10 g/10 min, or from 0.25 g/10 min to 10 g/10 min.

In one embodiment, the polypropylene compound can include commercially available polypropylene compounds such as Pro-fax polypropylene compounds by LyondellBasell, Braskem's random copolymer polypropylene, Formelene polypropylene compounds from Formosa Plastics Corporation, and mixtures thereof.

In addition to the elastomer and the polypropylene, the TPO composition of the present invention may also include other additional optional compounds or additives; and such optional compounds may be added to the composition with either the elastomer or the polypropylene. The optional additives or agent that can be used to prepare the TPO composition of the present invention can include one or more optional compounds known in the art for their use or function. For example, the optional additive (up to, for example, 5 wt %), colorants, oil, antioxidants, ultraviolet light (UV) stabilizers, scratch/mar resistant additives, processing aids, and mixtures thereof. Other minor components known in the art to modify, for example, stiffness, appearance, softness, and processing can be added to the TPO composition.

### Examples

### I. Raw Materials

TABLE 1
Raw Materials Tested

| Item | Raw Material | Composition | Technical Feature | Supplier |
|---|---|---|---|---|
| POE1 | ENGAGE ™ | Ethylene-octene | 0.863 g/cc | |
| | 8180 POE | (EO) copolymer | density, | The Dow |
| | | | Melt index = 0.5 | Chemical |
| | | | g/10 min (190° C., | Company |
| | | | 2.16 kg) | |
| POE2 | VERSIFY ™ | Propylene- | 0.867 g/cc | The Dow |
| | 2300 | ethylene (PE) | density, | Chemical |
| | Propylene- | copolymer | MFR = 2 (2.16 kg | Company |
| | based | | at 230° C.) | |
| | Elastomer | | | |
| POE4 | NORDEL ™ | EPDM, ethylene | 0.86 g/cc, | The Dow |
| | 3640 EPDM | content = 55 | Mooney | Chemical |
| | | wt %, diene | viscosity (ML 1 + 4 | Company |
| | | content (ENB) = | at 125° C.) = | |
| | | 1.8 wt % | 40 MU | |
| POE5 | NORDEL ™ | EPDM, ethylene | 0.88 g/cc, | The Dow |
| | 3745P EPDM | content = 70 | Mooney | Chemical |
| | | wt %, diene | viscosity (ML 1 + 4 | Company |
| | | content (ENB) = | at 125° C.) = | |
| | | 0.5 wt % | 45 MU | |
| POE6 | NORDEL ™ | EPDM, ethylene | 0.88 g/cc, | The Dow |
| | 4785HM | content = 68 | Mooney | Chemical |
| | EPDM | wt %, diene | viscosity (ML 1 + 4 | Company |
| | | content (ENB) = | at 125° C.) = | |
| | | 4.9 wt % | 85 MU | |
| POE7 | NORDEL ™ | EPDM, ethylene | 0.88 g/cc, | The Dow |
| | 4770P | content = 70 | Mooney | Chemical |
| | EPDM | wt %, diene | viscosity (ML 1 + 4 | Company |
| | | content (ENB) = | at 125° C.) = | |
| | | 4.9 wt % | 70 MU | |
| POE8 | NORDEL ™ | EPDM, ethylene | 0.91 g/cc, | The Dow |
| | 4820P | content = 85 | Mooney | Chemical |
| | EPDM | wt %, diene | viscosity (ML 1 + 4 | Company |
| | | content (ENB) = | at 125° C.) = | |
| | | 4.9 wt % | 20 MU | |
| POE9 | ENGAGE ™ | Ethylene-butene | 0.884 g/cc | The Dow |
| | HM 7280 | (EB) copolymer | density, | Chemical |
| | POE | | Mooney viscosity | Company |
| | | | (ML 1 + 4 at 150° | |
| | | | C.) = 42 MU | |
| POE10 | ENGAGE ™ | Ethylene-butene | 0.870 g/cc | The Dow |
| | HM 7387 | (EB) copolymer | density, | Chemical |
| | POE | | Mooney viscosity | Company |
| | | | (ML 1 + 4 at 121° | |
| | | | C.) = 54 MU | |
| LDPE1 | DOW ™ 132I | Ethylene | 0.921 g/cc | The Dow |
| | LDPE | homopolymer | density, | Chemical |
| | | low density | Melt index (190° | Company |
| | | polyethylene | C./2.16 kg) = | |
| | | | 0.25 g/10 min | |
| PP1 | Pro-fax | Polypropylene | 0.902 g/cc | LyondellBasell |
| | SR257M | random | density, | |
| | | copolymer | MFR (230° C./ | |
| | | | 2.16 kg) = 2.0 | |
| | | | g/10 min | |
| PP2 | PP F006EC2 | Polypropylene | MFR (230° C./ | Braskem |
| | | homopolymer | 2.16 kg) = 0.5 | |
| | | | g/10 min | |
| PP3 | C700-35 | Polypropylene | MFR (230° C./ | Braskem |
| | | impact | 2.16 kg) = 35 | |
| | | copolymer | g/10 min | |
| PP4 | INSPIRE 114 | Propylene | MFR (230° C./ | Braskem |
| | | Impact | 2.16 kg) = 0.5 | |
| | | Copolymer | g/10 min | |
| POE1 | ENGAGE ™ | Ethylene-octene | 0.863 g/cc | The Dow |
| | 8180 POE | (EO) copolymer | density, | Chemical |
| | | | Melt index = 0.5 | Company |
| | | | g/10 min (190° C., | |
| | | | 2.16 kg), 63 Shore | |
| | | | A hardness | |
| POE2 | VERSIFY ™ | Propylene- | 0.867 g/cc | The Dow |
| | 2300 | ethylene | density, | Chemical |
| | Propylene- | copolymer | MFR = 2 (2.16 kg | Company |
| | based | | at 230° C.), 88 | |
| | Elastomer | | Shore A hardness | |
| POE4 | NORDEL ™ | EPDM, ethylene | 0.86 g/cc, | The Dow |
| | 3640 EPDM | content = 55 | Mooney | Chemical |
| | | wt %, diene | viscosity (ML 1 + 4 | Company |
| | | content (ENB) = | at 125° C.) = | |
| | | 1.8 wt % | 40 MU | |
| POE5 | NORDEL ™ | EPDM, ethylene | 0.88 g/cc, | The Dow |
| | 3745P EPDM | content = 70 | Mooney | Chemical |
| | | wt %, diene | viscosity (ML 1 + 4 | Company |
| | | content (ENB) = | at 125° C.) = | |
| | | 0.5 wt % | 45 MU | |
| POE6 | NORDEL ™ | EPDM, ethylene | 0.88 g/cc, | The Dow |
| | 4785HM | content = 68 | Mooney | Chemical |
| | EPDM | wt %, diene | viscosity (ML 1 + 4 | Company |
| | | content (ENB) = | at 125° C.) = | |
| | | 4.9 wt % | 85 MU | |
| POE7 | NORDEL ™ | EPDM, ethylene | 0.88 g/cc, | The Dow |
| | 4770P EPDM | content = 70 | Mooney | Chemical |
| | | wt %, diene | viscosity (ML 1 + 4 | Company |
| | | content (ENB) = | at 125° C.) = | |
| | | 4.9 wt % | 70 MU | |
| POE8 | NORDEL ™ | EPDM, ethylene | 0.91 g/cc, | The Dow |
| | 4820P EPDM | content = 85 | Mooney | Chemical |
| | | wt %, diene | viscosity (ML 1 + 4 | Company |
| | | content (ENB) = | at 125° C.) = | |
| | | 4.9 wt % | 20 MU | |
| POE9 | ENGAGE ™ | Ethylene-butene | 0.884 g/cc | The Dow |
| | HM 7280 | copolymer | density, | Chemical |
| | POE | | Mooney viscosity | Company |
| | | | (ML 1 + 4 at 150° | |
| | | | C.) = 42 MU, 84 | |
| | | | Shore A hardness | |
| POE10 | ENGAGE ™ | Ethylene-butene | 0.870 g/cc | The Dow |
| | HM 7387 | copolymer | density, | Chemical |
| | POE | | Mooney viscosity | Company |
| | | | (ML 1 + 4 at 121° | |
| | | | C.) = 54 MU, 66 | |
| | | | Shore A hardness | |
| LDPE1 | DOW ™ 132I | Ethylene | 0.921 g/cc | The Dow |
| | LDPE | homopolymer | density, | Chemical |
| | | low density | Melt index (190° | Company |
| | | polyethylene | C./ 2.16 kg) = | |
| | | | 0.25 g/10 min | |
| PP1 | Pro-fax | Polypropylene | 0.902 g/cc | LyondellBasell |
| | SR257M | random | density, | |
| | | copolymer | MFR (230° C./ | |
| | | | 2.16 kg) = 2.0 | |
| | | | g/10 min | |
| PP2 | PP F006EC2 | Polypropylene | MFR (230° C./ | Braskem |
| | | homopolymer | 2.16 kg) = 0.5 | |
| | | | g/10 min | |
| PP3 | C700-35 | Polypropylene | MFR (230° C./ | Braskem |
| | | impact | 2.16 kg) = 35 | |
| | | copolymer | g/10 min | |
| PP4 | INSPIRE 114 | Propylene | MFR (230° C./ | Braskem |
| | | Impact | 2.16 kg) = 0.5 | |
| | | Copolymer | g/10 min | |

### II. Experimental Procedures

The formulations (see Tables 3 and 4 below) were compounded on a 42:1 27 mm co-rotating twin screw extruder produced by Leistritz at a rate of ˜32 lb/hr. The zone temperature was 160° C., 190° C., 200° C. for zones 1, 2, and 4-9, respectively. The extruder was run at a 200 rpm. A dual 3 mm hole strand die was utilized with at a temperature of 200° C. The strands were cooled through a room temperature (RT) water bath and ran through a pelletizer. The pellets were allowed to air dry for 48 hours.

The compound pellets were extruded into sheet on a 1.5″, 24:1 L/D Killion single screw extrusion line. A 6″ coat hanger die was used to produce sheet with a thickness of 0.5 mm. A three-roll stack with three chrome polish rolls. Basic run conditions are described in Table 2 below.

TABLE 2
General run conditions for sheet extruding on the 1.5″ Killion line

| Parameter | Setting | Note |
|---|---|---|
| Extruder RPM | 7-11 | Throughput estimated |
| | | at ~15 lb/hr |
| Barrel Zone 1, 2, 3, and | 185° C., 198° C., | Melt temperature |
| clamp/adapter | 202° C. and 202° C. | ~205° C. |
| temperatures | | |
| Die Zone 1, 2, and 3 | 213° C., 232° C., and | |
| | 218° C. | |
| Roll Stack | 27° C., 32° C., 38° C. | |
| (Top/Middle/Bottom) | | |

TABLE 3
Tested Formulations (Round 1) in weight (%)

| | CE1 | CE2 | CE3 | IE4 | CE5 | CE6 | CE7 | IE15 |
|---|---|---|---|---|---|---|---|---|
| | Form | Form | Form | Form | Form | Form | Form | Form |
| Component | 1 | 2 | 3 | 4 | 5 | 6 | 7 | 15 |
| POE 1 | 77.5 | 63.75 | | | | | | |
| POE 2 | | 21.25 | | | | | | |
| POE 4 | | | 77.5 | | | | | |
| POE 5 | | | | 77.5 | | | | 72.5 |
| POE 6 | | | | | 77.5 | | | |
| POE 7 | | | | | | 77.5 | | |
| POE 8 | | | | | | | 77.5 | |
| LDPE1 | | | | | | | | 5 |
| PP1 | 22.5 | 15 | 22.5 | 22.5 | 22.5 | 22.5 | 22.5 | 22.5 |

TABLE 4
Tested Formulations (Round 2) in weight (%)

| | IE8 | CE9 | CE10 | CE12 | CE13 | CE14 |
|---|---|---|---|---|---|---|
| | Form | Form | Form | Form | Form | Form |
| Component | 8 | 9 | 10 | 12 | 13 | 14 |
| POE 5 | 70 | 85 | | 77.5 | 77.5 | |
| POE 9 | | | 75 | | | |
| POE 10 | | | | | | 70 |
| PP1 | 30 | 15 | | | | |
| PP2 | | | | | 22.5 | |
| PP3 | | | 25 | 22.5 | | |
| PP4 | | | | | | 30 |

To measure the acceptability of the formulations above, the following tests were conducted.

Density values are provided from technical data sheets for the raw materials and were measured in accordance with ASTM D792, Method B (g/cc or g/cm3).

Mooney viscosity—ML 1+4 at 125° C. was measured per ASTM D1646 with a one minute preheat time and a four minutes rotor operation time. Test temperature is 125° C. unless stated otherwise in the raw material table. Data reported was obtained from technical data sheets. Mooney viscosity is reported in Mooney units (MU).

Melt Flow Rate (MFR) for propylene-based polymers was measured according to ASTM D1238, Condition 230° C./2.16 kilogram (kg) weight unless otherwise noted. Data reported was obtained from technical data sheets.

Ethylene, Mass %—measured per ASTM D3900. Data reported for raw materials was obtained from technical data sheets.

Shore A Hardness—0.5 mm thick sheet samples were stacked to a thickness of ˜6.0 mm (˜12 sheets). The Shore A hardness was measured with a durometer tester per ASTM D2240 with a 10 second dwell.

Visual perception properties—total transmittance, haze, and clarity were measured utilizing a BYK Gardner haze-gard plus model 4725. BYK equipment conforms to ASTM D1003 for total transmittance and haze. Total transmittance, haze, and clarity are reported in percent, %.

Capillary Viscosity—capillary viscosity was measured per ASTM D3835-16 at 215° C. and X400-20 die (a 1.016 mm diameter×20.320 mm length die with a 120° cone angle) at a shear rate of 10 s⁻¹ to 10,000 s⁻¹.

Extensional Viscosity Fixture (EVF)—a rotating drum designed with a controlled strain rate of 0.1 s⁻¹ and tested at 190° C. Measurements are obtained using a TA Instruments ARES Classic RSAIII outfitted with the EVF geometry accessory. Elongational viscosity ratio is determined by dividing the elongational viscosity at 1.0 Hencky strain by the elongation viscosity at 0.25 Hencky strain.

Grain Retention—grain retention is assessed on a sheet that is embossed with a leather like grain pattern that is approximately 150 μm from the top of the grain structure to the base. The sheeted 0.5 mm thick samples were cut into 6-inch lengths. The samples were placed onto a conditioned (mold release applied) grain surface tool with a 0.4 mm photo frame around it and Teflon sheet on top. The stack was placed into a 2′×2′ compression molder and pressed at 20 tons for 4 mins at 190° C. The sample was then pulled out and cooled between two chilled platens at 23° C. for 2 minutes before being removed. Each individual sample was cut into approximately 3″×3″ square and the dimensions were measured precisely to be able to determine final % shrinkage. The embossed sheet is measured for 60° gloss and placed in an oven on a bed of talc at 120° C. for 7 days. Change in gloss level, area and visual grain appearance are assessed. The gloss increase after heat aging cannot be more than one unit from original measurement. The area loss cannot be more than 4% and the visual appearance of the grain cannot change.

Gloss—60° gloss was measured with a BYK Gardner 4561 Micro-Gloss Meter on the grained sides of the soft TPO skins.

### III. Results

TABLE 5
Test results for formulation Round 1

| | | | CE3 | IE4 | CE5 | | | |
|---|---|---|---|---|---|---|---|---|
| | CE1 | CE2 | Form | Form | Form | CE6 | CE7 | IE15 |
| Component | Form 1 | Form 2 | 3 | 4 | 5 | Form 6 | Form 7 | Form 15 |
| Shore A | 82 | 89 | 60 | 82 | 79 | 81 | 94 | 86 |
| (target <88) | Pass | Fail | Pass | Pass | Pass | Pass | Fail | Pass |
| Total transmittance | 88 | 91 | 85 | 91 | 91 | 90 | 92 | 91 |
| (target >88) | Fail | Pass | Fail | Pass | Pass | Pass | Pass | Pass |
| Clarity | 73 | 65 | 44 | 81 | 64.4 | 29 | 95 | 78 |
| (target >65%) | Pass | Fail | Fail | Pass | Fail | Fail | Pass | Pass |
| Haze | 39 | 21 | 60 | 18 | 34.6 | 80 | 20 | 21 |
| (Target <35%) | Fail | Pass | Fail | Pass | Pass | Fail | Pass | Pass |
| EVF ratio | 1.5 | 1.25 | 1.7 | 1.8 | 1.9 | 2.3 | 1.6 | 2.3 |
| (target >1.5) | Fai | Fail | Pass | Pass | Pass | Pass | Pass | Pass |
| EVF at 0.25 Hencky | 68k | 48k | 88k | 205k | 282k | 364k | 51k | 286k |
| strain | Fail | Fail | Fail | Pass | Pass | Pass | Fail | Pass |
| (target >90k Pa · s) | | | | | | | | |
| Capillary Visc at 215 | Not | NT | 1600 | 1750 | 2600 | 1881 | 1450 | 1711 |
| ° C. and 100 s⁻¹ | Tested | | Pass | Pass | Fail | Pass | Pass | Pass |
| (target <1900 Pa · s) | (NT) | | | | | | | |
| Grain Retention at | Fail | NT | Fail | Pass | Pass | NT | Fail | Pass |
| 120° C. | | | | | | | | |
| Elastomer Type | EO | EO + PE | EPDM | EPDM | EPDM | EPDM | EPDM | EPDM |

The inventive examples in Table 5 and Table 6 comprise an EPDM with specific characteristics (i.e., ethylene content from 60 to 80 wt % and Mooney viscosity from 30 to 60) in combination with an random copolymer polypropylene within a particular melt flow rate range to provide a unique balance of properties, including high light transmittance, high clarity, low haze, softness (low Shore A), low shear viscosity to enable extrusion without excessive torque, and high extensional viscosity to enable thermoforming. Using an elastomer with lower viscosity results in low elongational viscosity and poor grain retention, as demonstrated by CE 7. Using an elastomer with higher viscosity results in high viscosity making the formulation difficult to extrude at high rates and/or creating surface roughness that results in low clarity and/or high haze, as demonstrated by CE5 and CE6. Using an EPDM with lower ethylene content results in poor grain retention at elevated temperatures due to the low melting temperature of the elastomer, as demonstrated by CE3. Meanwhile, using an EPDM with higher ethylene content results in high hardness of the formulation due to higher crystallinity of the elastomer, as demonstrated by CE7.

In addition, the amount of EPDM in the inventive formulations is critical to providing the desired balance of properties. When the EPDM level is less than 70 wt % the formulation may have high hardness. When the EPDM level is greater than 84 wt %, the grain retention is poor because there is not enough polypropylene in the formulation, as demonstrated by CE9. Use of homopolymer polypropylene or impact copolymer polypropylene result in low light transmittance, as demonstrated by CE12, CE13, and CE14.

### Round 1 Analysis:

Formulation 1 with substantially linear ethylene-octene (EO) type random polyolefin elastomers doesn't have the needed melt strength to thermoform or temperature resistance (grain retention at 120° C.).
Formulation 2 with substantially linear EO type random polyolefin elastomer combined with propylene-ethylene (PE) type random polyolefin results in material that doesn't have the needed melt strength to thermoform—low EVF ratio and low EVF at 0.25 Hencky strain.
Formulation 3 with low ethylene content (55 wt % ethylene type of EPDM) doesn't exhibit acceptable visual perception properties, fails grain retention. The EPDM material at 55 wt % ethylene content was very difficult to feed into the TSE due to the tendency of the granules to fuse together. Higher ethylene content in the EPDM is needed for handling, ease of processing and high temperature resistance.
Formulation 4 containing EPDM with 70 wt % ethylene content and 45 Mooney viscosity meets all target performance properties. Use of EPDM with 45 Mooney viscosity result in a compound with capillary viscosity below 1900 Pa·s, which likely reduces melt fracture compared to formulation with >60 Mooney viscosity, resulting in good visual perception properties. Mooney viscosity is high enough to provide good EVF properties for thermoforming. Ethylene content of the EPDM is low enough so that the compound exhibits softness <88 Shore A hardness, yet is sufficient to be produced in a free flowing granule form for ease of handling during processing. 22.5 wt % polypropylene level is sufficient for grain retention after 120° C. temperature exposure.
Formulation 5 containing EPDM with too high Mooney viscosity of 85 has capillary viscosity that is too high (2,600 Pa·s measured and requirement is <1900 Pa·s). This capillary viscosity>1900 Pa·s could cause melt fracture and surface roughness during the extrusion process resulting in unacceptable low clarity performance.
Formulation 6 containing EPDM with too high Mooney viscosity of 70 has capillary viscosity near the upper target of <1900 Pa·s. This high viscosity might cause melt fracture and surface roughness when flowing through the extrusion die, resulting in low clarity and high haze measurements.
Formulation 7 containing EPDM with 85 wt % ethylene content has hardness that is too high. 20 Mooney viscosity of the EPDM is too low, resulting in a formulation with elongational viscosity at 0.25 Hencky strain that might be too low for preventing sag during thermoforming.
Formulation 15 is similar to IE4 with the addition of 5 wt % LDPE. The use of LDPE is known to reduce melt fracture and surface roughness due its branching structure. This reduced melt fracture can result in improved surface clarity. Formulation 15 meets all target performance properties.

TABLE 6
Test results for formulation Round 2

| | IE8 | CE9 | CE10 | CE12 | CE13 | CE14 |
|---|---|---|---|---|---|---|
| | Form | Form | Form | Form | Form | Form |
| Component | 8 | 9 | 10 | 12 | 13 | 14 |
| Shore A | 87.8 | 76 | 89 | 81 | 85 | 84 |
| (target <88) | Pass | Pass | Fail | Pass | Pass | Pass |
| Total | 90 | 92 | 82 | 88 | 88 | 87 |
| transmittance | Pass | Pass | Fail | Fail | Fail | Fail |
| (target >88%) | | | | | | |
| Clarity | 73 | 88 | 61 | 50 | 77 | 37 |
| (target >65%) | Pass | Pass | Fail | Fail | Pass | Fail |
| Haze | 28 | 13 | 86 | 55 | 40 | 35 |
| (Target <35%) | Pass | Pass | Fail | Fail | Fail | Fail |
| EVF ratio | 1.8 | 1.9 | 1.7 | NT | NT | 1.8 |
| (target >1.5) | Pass | Pass | Pass | | | |
| EVF at | 198k | 212k | 177k | NT | NT | 240k |
| 100 s⁻¹ | Pass | Pass | Pass | | | Pass |
| (target >90k | | | | | | |
| Pa · s) | | | | | | |
| Capillary | 1416 | 2320 | 1050 | NT | NT | 1846 |
| Viscosity at | Pass | Fail | Pass | | | Pass |
| 215° C. and | | | | | | |
| 100 s⁻¹ | | | | | | |
| (target <1900) | | | | | | |
| Grain | Pass | Fail | NT | NT | NT | Pass |
| Retention at | | | | | | |
| 120° C. | | | | | | |
| Elastomer | EPDM | EPDM | EB | EPDM | EPDM | EB |
| Type | | | | | | |
| Other | | | | rcPP | rcPP | Rheology |
| | | | | replaced | replaced | Example |
| | | | | with | with | |
| | | | | icPP | hPP | |

### Round 2 Analysis:

Formulation 8: Increasing PP level to 30 wt % causes Shore A hardness to be at the upper limit. Since Shore A hardness is at the limit of 88, levels of PP should be <30 wt %. Formulation 8 meets all target performance properties.

Formulation 9: PP level of 15 wt % is too low and results in both poor grain retention after high temperature heat exposure and excessive capillary viscosity.

Formulation 10: High melt strength ethylene-butene elastomer exhibit high haze and low clarity.

Formulation 12: Substituting impact copolymer polypropylene for random copolymer polypropylene in formulation 4 causes low clarity and high haze (hypothesized due to coarse PP morphology in mix). Melt flow of PP is also too high.

Formulation 13: Substituting homopolymer polypropylene for random copolymer polypropylene in formulation 4 causes high haze (hypothesized due to coarse PP morphology in mix).

Formulation 14 is used for establishing both EVF targets and capillary viscosity targets.

1. An elastomer skin composition, comprising:
based on the weight of the elastomer skin composition 70 wt % to 85 wt % of at least one ethylene propylene diene terpolymer (EPDM), wherein the at least one EPDM comprises, based on the weight of the at least one EPDM, 60 wt % to 80 wt % ethylene and less than 5 wt % diene, and wherein the at least one EPDM has a Mooney viscosity at ML 1+4 at 125° C. of greater than 30 and less than 60 as measured per ASTM D1646; and
at least one polypropylene copolymer component, wherein the at least one polypropylene copolymer component comprises, based on the weight of the at least one polypropylene copolymer component, greater than 15 wt % and less than or equal to 30 wt % clarified polypropylene random copolymer.

2. The elastomer skin composition of claim 1, wherein the melt flow rate of all of the at least one polypropylene copolymer component is less than 10 g/10 min.

3. The elastomer skin composition of claim 1, wherein the elastomer skin composition comprises 70 wt % to 77.5 wt % of the at least one EPDM.

4. The elastomer skin composition of claim 1, wherein the elastomer skin composition comprises based on the weight of the elastomer skin composition 22.5 wt % to 30 wt % of the at least one polypropylene copolymer component, and wherein total weight of the at least one EPDM and the at least one polypropylene copolymer component adds up to 100% based on the weight of the elastomer skin composition.

5. A product made from the elastomer skin composition of claim 1.

6. The product of claim 5, wherein the product comprises an automotive part.

7. The product of claim 5, wherein the product has a Shore A hardness of less than 88.

8. The product of claim 5, wherein the product has a total transmittance of greater than 88%, clarity of greater than 65%, and haze of less than 35% as measured by ASTM D1003.

9. The product of claim 5, wherein the product does not contain colorants.

10. The product of claim 5, wherein the product has a capillary viscosity of less than 1900 Pa·s at 215° C. and at shear rate of 100 s⁻¹.

11. The product of claim 5, wherein the product has an elongational viscosity fixture ratio of greater than 1.5.
